(19) United States
(12) Patent Application Publication
(10) Pub. No.: US 2022/0005120 A1
(43) Pub. Date: Jan. 6, 2022

(54) Method and System For Displaying Investment Returns

(71) Applicant: Troutwood, LLC, Pittsburgh, PA (US)

(72) Inventors: Eugene M. Natali, JR., Pittsburgh, PA (US); Jeffrey Richard Davidek, Pittsburgh, PA (US); Dorian Brown, Pittsburgh, PA (US)

(73) Assignee: Troutwood, LLC, Pittsburgh, PA (US)

(21) Appl. No.: 17/368,124

(22) Filed: Jul. 6, 2021

Related U.S. Application Data
(60) Provisional application No. 63/048,480, filed on Jul. 6, 2020.

(51) Int. Cl. G06Q 40/06; G06Q 10/06; G06Q 10/10; G06F 16/2458; G06F 3/0482; G06F 3/0484

(52) U.S. Cl. CPC G06Q 40/06; G06Q 10/067; G06F 3/04847; G06F 16/2474; G06F 3/0482; G06Q 10/1057

(57) ABSTRACT

An investment learning system is provided and includes a personal computer device having a single general user interface and a central processing unit and a performance management server connected to the personal computer device and having a non-transitory computer readable storage device having a database module for calculating and displaying simulated investment snapshot for a custom investment period utilizing historical data and user controlled inputs, and a central processing unit connected to the personal computer device and the computer readable storage device, and running a plurality of core modules to map and link individual action items to calculate and generate integrated financial and managerial summaries. The plurality of core modules include a first input module to select a time period and a result module to generate simulated financial results based on historical events during that selected time period.

### CROSS-REFERENCE TO RELATED APPLICATION

This application claims the benefit of U.S. Provisional Patent Application No. 63/048,480, filed on Jul. 6, 2020.

### FIELD OF INVENTION

This disclosure relates to financial investment education and, more particularly, to a system providing financial investment education by displaying simulated modeling of investment returns, innovation, education, recessions, economics, actual career cycles, the consumer and politics through historical events and actions.

### BACKGROUND

Approximately 115 million Americans do not invest. Basic education teaching investment “know how” is greatly lacking, and traditional pension fund availability is sharply declining a trend likely to persist. Whereas retirement has historically been “employer directed” it is quickly becoming “employee directed”. There is not a greater need within financial education, than understanding the necessity of tools to prepare Individuals for this changing retirement landscape. Financial challenges to the general population are numerous, including a student loan crisis, which continues to grow. Corporations and even municipal and state governments are freezing or eliminating their pension plans. The minimum age for Social Security eligibility has risen and may continue to rise, while the level of benefits may potentially be diminished in the future as the result of inflation or budgetary concerns. This cumulative reduction of the United States retirement safety net is an issue of national importance. The demand and need to help Americans, particularly young Americans, develop viable plans to achieve financial stability is very high. What is needed is a system that will help users develop viable plans, collect useful data, provide modeling of financial outputs in response to entered variables, and optionally provides for a financial simulation activity that may be utilized as part of an education curriculum. Such a system may beneficially provide users with a better understanding of the impact of financial decisions and life choices, and provide positive reinforcement and communication to help users recognize the need for, implement, maintain, and successfully realize those financial plans and goals. An important skill as retirement becomes employee directed for most individuals.

Federal agencies have been collecting vast amounts of data, in discrete data sets related to income and expenses, for many years. However, there is no agency assigned with the task of integrating these various data sets, from varying agencies, into a tool specifically intended to help users create a financial budgeting plan tailored to his or her own unique financial objective or to simulate the potential impact of personal financial decisions—even though the vast data could be extremely valuable in doing so. The agencies that collect and publish the data make no attempt to interpret the data as it pertains to unique individuals and do not offer any tool designed to communicate, in an easily understandable format, with users to reinforce positive investment behavior consistent with individual savings and investment objectives. What is needed is a system that will utilize published data, along with user inputs pertaining to the specific individual use, to provide useful savings and budget information, and financial simulations, to help the user achieve desired investment understanding.

Further, statistics show that many young adults fail to appreciate the need for long-term investing or are intimidated by the process. As a result, many young professionals fail to invest or fail to continue investing early in their professional careers. Uneducated investors may emotionally react to adverse near term events in the overall marketplace and sell without concern of the impact on their probability of achieving long term goals. The early years of an investment life cycle, paired with less investment know-how at this stage, often result in younger individuals being most prone to making mistakes and pulling investments for substantial losses or failing to continue investing—counterproductive both individually and societally, especially when viewed in the light of their remaining human capital and theoretical ability to continue contributing to their investment portfolio for many years to come. The early years of an investment life cycle are precisely the stage where the potential for individual and societal benefit is greatest, if young investors are educated and able to invest with understanding and discipline and discipline potentially adverse circumstances can be avoided. The institutional investment model applied by many pension funds, endowments, and foundations, which emphasize fiduciary obligation to planning, understanding, and risk controls is an example of the validity and applicability to individuals, particularly young investors, to also staying the course and maintaining a long-term focus. Historically pension funds were responsible for managing employees retirement money—opting out wasn't a choice. As traditional pension funds continue to decline in availability, individuals are being thrust into filling that role, but without the education/preparation to do so. The combination must be reversed. Individuals must be prepared to direct their retirement assets, for long-term success.

Therefore, there is a need to demonstrate the value of long-term investing, even when faced with adverse conditions that have occurred frequently over the course of all prior career cycles and a long term investment periods.

### SUMMARY

Accordingly, a system and process for transforming custom input data into a displayable simulated investment snapshot is provided. The system according to the invention provides simulated modeling of investment returns, innovation, education, economics through historical events and actions in order to educate the user on investment growth. The system does this by displaying an investment snapshot of simulated trends using historical data, and engaging the user, a non-investor, to better understand the value and benefits of investing. Specific examples of EVERY career cycle dating back to 1926, help users understand the efficacy of long-term investing, and how narrow the performance difference is when looked at over the long-run. This is a critical awareness as individuals are being asked to self-direct their retirement portfolios. Traditional pension funds are designed to operate for perpetuity, creating a long-term focus. Individuals must similarly adapt and be given the tools to understand a long-term focus to increase the odds of successfully managing self-directed retirement plans including, 401(k), 403(b), 457(k), Roth IRA, Roth 401k(k), and others.

The system according to the invention is a simulation system tool that uses historical returns to generate a simulated return on investment based on a selected amount of initial and/or recurring investment over time. Career cycle breakdowns, paired with emphasis on the historical milestones and recessions, help users understand that they too will experience recessions. Specific recession modeling allows users to learn investment skills, like “dollar cost averaging” through downturns.

### BRIEF DESCRIPTION OF THE DRAWINGS

The invention will now be described by way of example with reference to the accompanying figures of which:

FIG. 1 is a screenshot of a user interface home screen for an investment learning system according to the invention;

FIG. 2 is another screenshot of the user interface home screen for an investment learning system according to the invention showing a first input module;

FIG. 3 is another screenshot of the user interface home screen for an investment learning system according to the invention showing selection of historical events;

FIG. 4 is another screenshot of the user interface home screen for an investment learning system according to the invention showing a first input module;

FIG. 5 is another screenshot of the user interface home screen for an investment learning system according to the invention showing default selection of a second input and third input;

FIG. 6 is another screenshot of the user interface home screen for an investment learning system according to the invention showing user selection using a second input module and a third input module;

FIG. 7 is another screenshot of the user interface home screen for an investment learning system according to the invention showing simulated financial results using the results module;

FIG. 8 is another screenshot of the user interface home screen for an investment learning system according to the invention showing data using a political data module;

FIG. 9 is another screenshot of the user interface home screen for an investment learning system according to the invention showing economic data using an economic data module;

FIG. 10 is another screenshot of the user interface home screen for an investment learning system according to the invention showing further economic data using the economic data module;

FIG. 11 is another screenshot of the user interface home screen for an investment learning system according to the invention showing further economic data using the economic data module;

FIG. 12 is another screenshot of the user interface home screen for an investment learning system according to the invention showing further economic data using the economic data module;

FIG. 13 is another screenshot of the user interface home screen for an investment learning system according to the invention showing further result in dichromatic format using the results module;

FIG. 14 is another screenshot of the user interface home screen for an investment learning system according to the invention showing facts using a facts module;

FIG. 15 is another screenshot of the user interface home screen for an investment learning system according to the invention showing selection of a “what if” module;

FIG. 16 is another screenshot of the user interface home screen for an investment learning system according to the invention displaying data in a dichromatic format using a “what if” module;

FIG. 17 is another screenshot of the user interface home screen for an investment learning system according to the invention displaying further data in a dichromatic format using the “what if” module; and

FIG. 18 is a schematic diagram of hardware infrastructure for an investment learning system according to the invention.

### DETAILED DESCRIPTION OF THE EMBODIMENT(S)

Embodiments of the present invention will be described hereinafter in detail with reference to the attached drawings, wherein like reference numerals refer to the like elements. The present invention may, however, be embodied in many different forms and should not be construed as being limited to the embodiments set forth herein; rather, these embodiments are provided so that the disclosure will be thorough and complete and will fully convey the concept of the invention to those skilled in the art.

Other systems, methods, features and advantages of the invention will be or will become apparent to one with skill in the art upon examination of the following figures and detailed description.

In an embodiment, the teachings herein described a system and process that converts custom input data into a displayable and easy to understand simulated investment snapshot for a custom investment period utilizing historical data and user controlled inputs, as variables in the software.

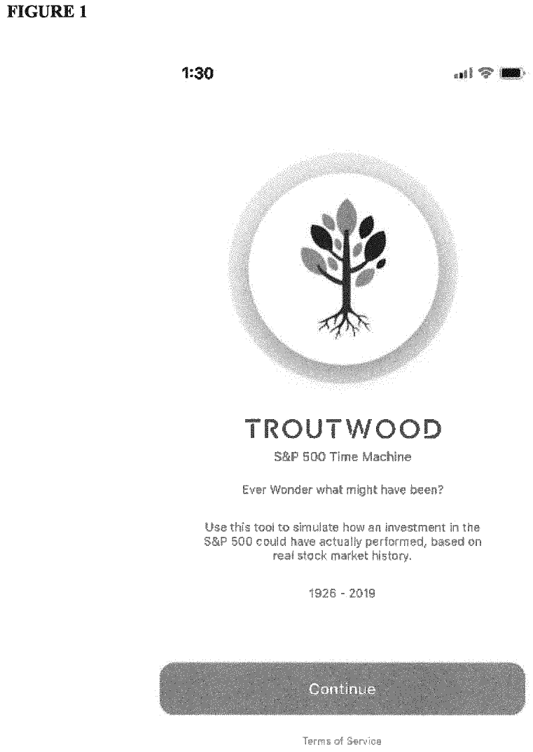

In an exemplary embodiment of the invention, the system transforms and displays simulated long term investment results and trends using historical events. In an embodiment of the invention, this is performed through an investment learning system that may be an app or web based simulation system tool, as shown in FIG. 1. The investment learning system employs software and hardware.

Hardware infrastructure for an embodiment of the investment learning system will be described. In an exemplary embodiment, the investment learning system is built on a network router (for instance, a wireless router) and connected to a database server, while also utilizing known hardware components, including a web server, a firewall, a network, and the computing device.

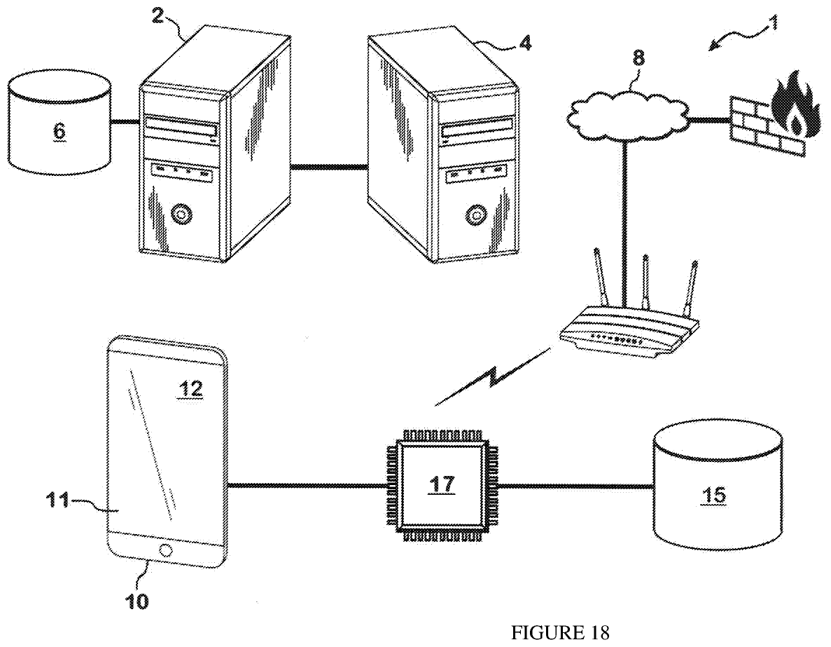

Referring first to FIG. 18, hardware infrastructure for an embodiment of the investment learning system 1 will be described. To perform the aforementioned and other functions, the investment learning system 1 generally includes a plurality of integrated system servers 2, 4 with one or more databases 6 (i.e., internal information repository), a network interface 8 accessible through various known communication protocols, such as TCP/IP, cellular protocols including GSM, Wi-Fi, Wi-Max, or other wireless communications technologies or combination of wired or wireless channels, network security devices (where necessary), and a computing device 10 having a processing unit 17 and memory 15.

The investment learning system 1 allows a user to access to a plurality of system files that includes data, such as information and images, through the computing device 10 and a network traffic information on the database server 4 (i.e. SQLServer or PostgreSQL (also known as Postgres) or newer) that connects to a web server 6. The web server 4 functions as a way for network interface 8 to communicate to the database server 2 through known application-programming interface (API) between the computing device 10 and the database server 4. A firewall may be used for security purposes such as, but is not limited to, blocking unauthorized access to the web server 6 and permitting unauthorized communication thereto. The investment learning system 1 is designed to run through the computing device 10 through an investment learning system module that can be downloaded over personal area networks (PANs), local area networks (LANs), campus area networks (CANs), wide area networks (WANs), metropolitan area networks (MANs) and any new networking system developed in the future. One skilled in the art should appreciate that the investment learning system 1 can be maintained solely through the computing device 10, as the investment learning system modules can be pre-loaded to the computing device 10. The computing device as depicted having a processor 17 for performing the necessary calculations and performing the actions for the investment learning module having a plurality of service modules within the investment learning module, and also having memory 15, configured for storing and accessing the investment learning system files, including market return data and formulas that may be employed in the investment learning simulation. In the shown embodiment, the user may connect to the network interface 8 using the computing device 10 through the router for instance. One skilled in the art would appreciate that other hardware and protocol designs are possible as long as such modifications would not divert from the spirit of the invention.

In an exemplary embodiment, as shown in FIG. 1, the computing device 10 generally includes a general user interface 12, a memory device 15, and a processor 17. In the shown embodiment, the computing device is a tablet computer or mobile phone with a touchscreen display 11. The touchscreen display 11 uses finger or stylus gestures to navigate the general user interface (GUI) 12. However, one skilled in the art should appreciate that other implements could be used; including a computer mouse, a keyboard, or joystick. In fact, one skilled in the art should appreciate that the computing device 10 is a physical computer and could be, but not limited to, a desktop computer, a laptop computer, or a cell phone, and utilize a downloaded app or web browser. The memory device 15 is a storage device having computer components and recording media used to retain digital data. The processor 17 is a central processing unit (CPU) that manipulates data stored in the memory device by performing computations. In an alternative embodiment, the investment learning system files, including market return data and formulas, and programming language necessary for performing the simulation may be loaded into the memory device 15 of the computing device 10, and performable by the processor 17, utilizing user inputs through the interface 11, as will be described. In such an embodiment, there may be no need for communication through the network interface 8 to communicate with external devices (e.g. servers 2, 4) through a network router.

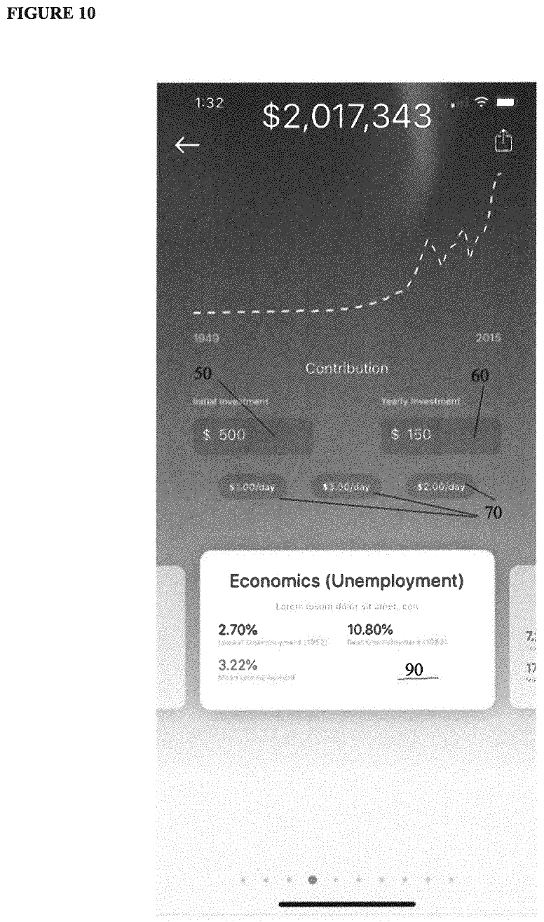

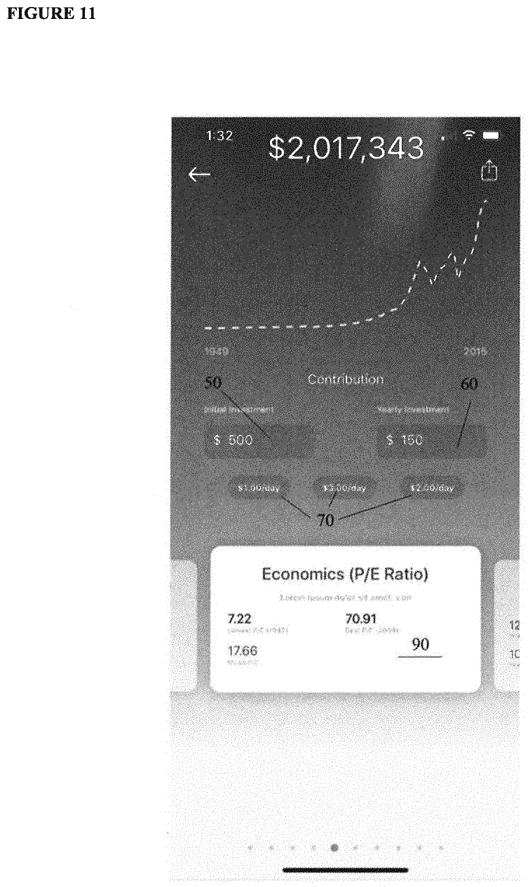

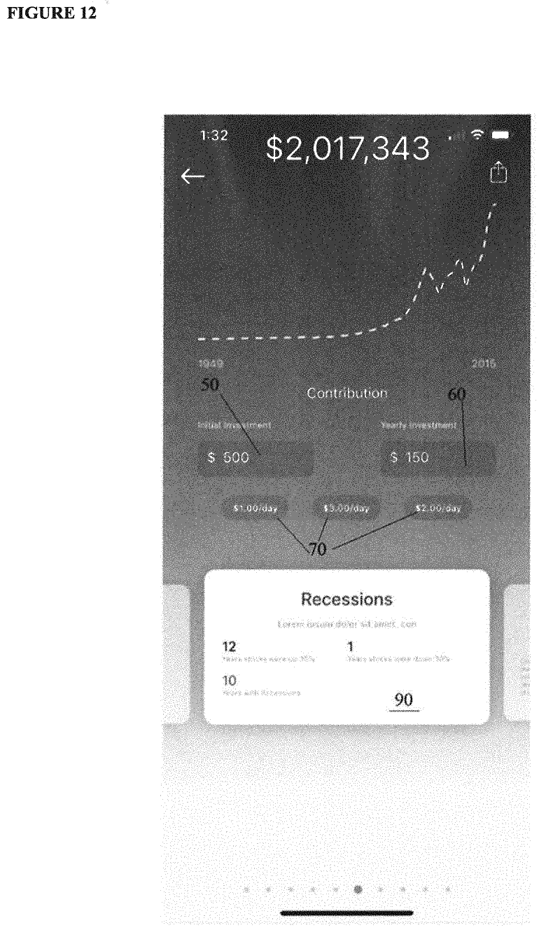

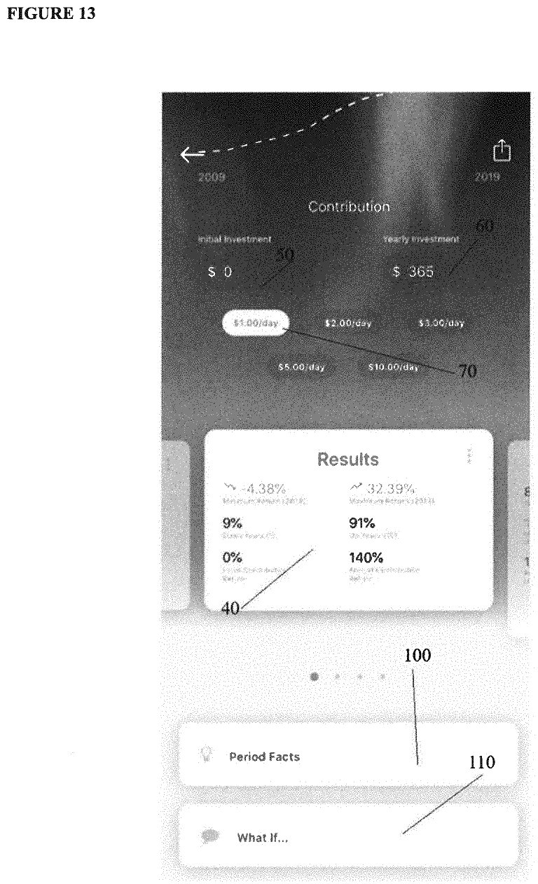

Now, with reference to FIGS. 1-17, an embodiment of the investment learning system will be described by way of illustration of using a general user interface 10 for the computing device. In the shown embodiment, the investment learning system runs selected user options versus known historical return data, such as the S&P 500, to generate simulated financial growth of a user account over a selected investment period. In the shown embodiment, the selected user options are date period customization, monetary customization, and overall time period customization.

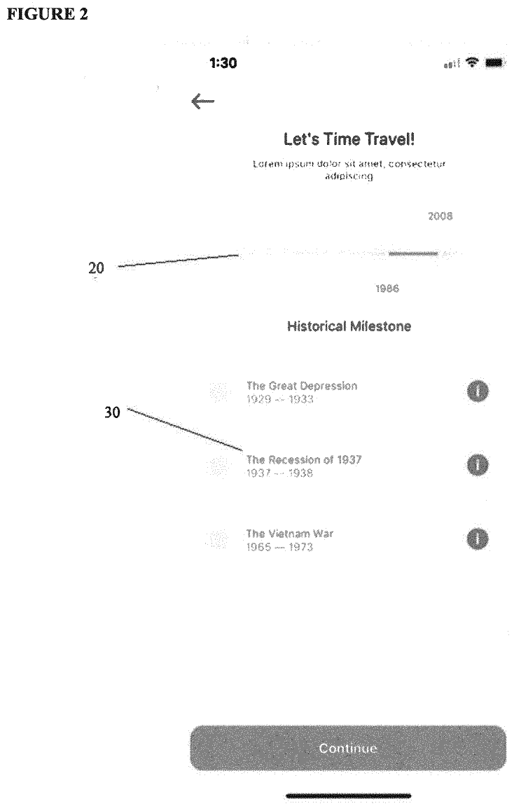

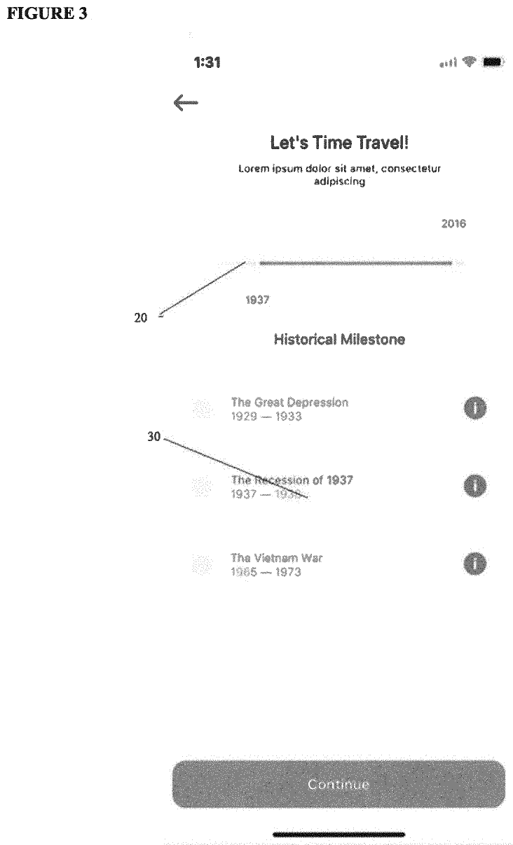

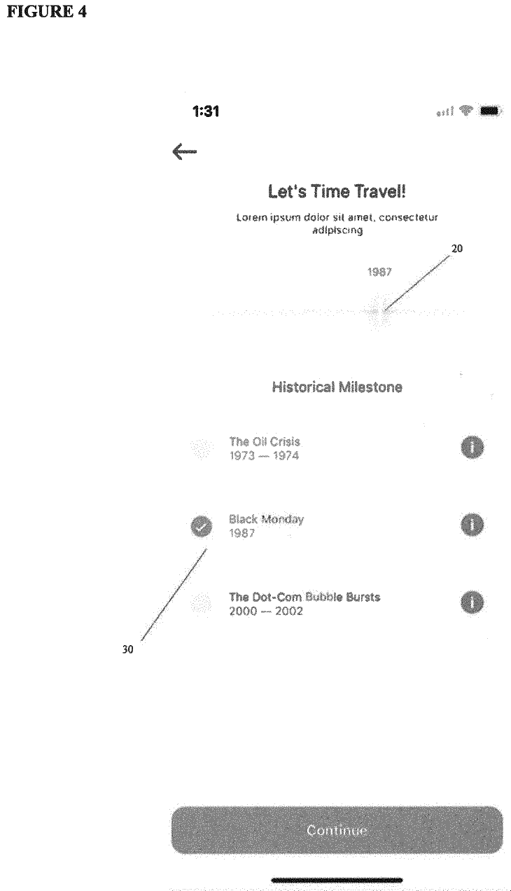

In the shown embodiment, the user would first select a starting and ending time period (i.e. between 1926-2019). As shown in FIGS. 2 and 3, a first input module 20, which is activated by sliding a start date and an end date to reflect the select time period to simulated investment results based on historical events during that time period. In the shown embodiment, the investment learning system may list a series of known historical events that had major influence on the U.S. or world economy. This would be done by time period, and the user can select what historical events are includes in the simulated investment results (see FIG. 4) through a second input module 30. The embodiment allows for specific modeling of such events and time periods.

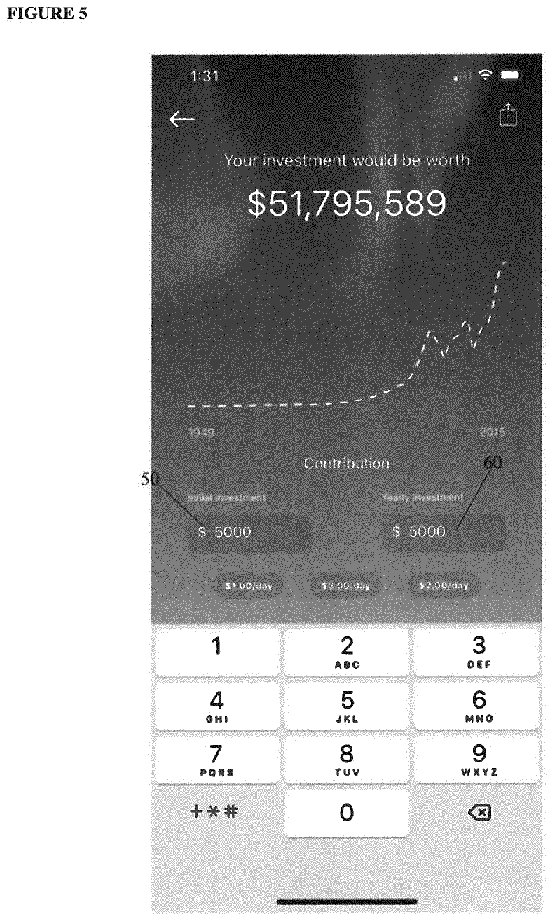

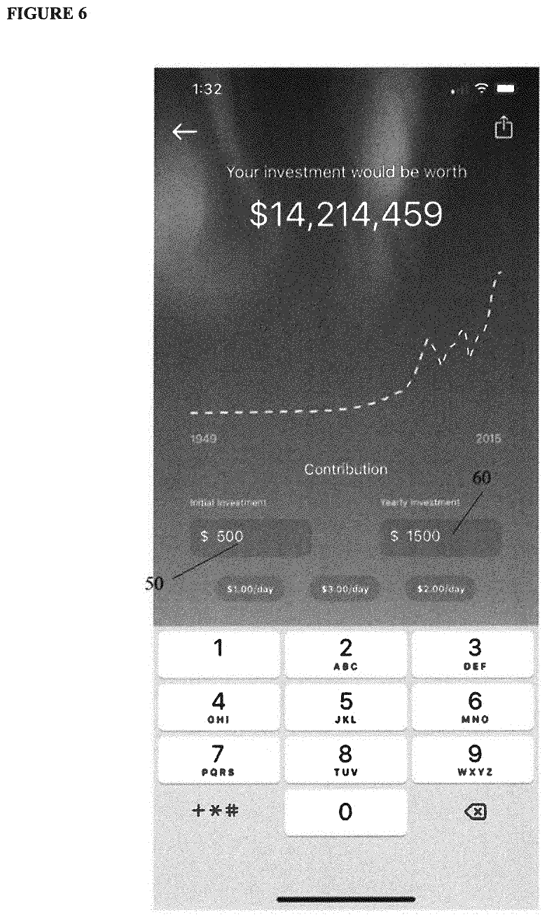

Once the time period has been selected, the investment learning system will generate simulated trend and financial results for the selected time period based on default initial investment and default yearly investment. This is done by selecting relevant data from the database or the start of the year, end of year and all years in between. Each row contains historical data to be run by a result module 40 to generate simulated financial results, based on actual historical returns, using selected custom initial investment and yearly investment (see FIGS. 5 and 6).

In an embodiment of the invention, the investment learning system intentionally limits the user to three (3) inputs for simplicity of understanding and maintaining focus. This system design benefits the user by alleviating them of the burden of gathering and processing multiple vast, discrete data sets and of having to determine relevant underlying data relationships and correlations. This relationship further provides the benefit of simplifying a concept, investing, which is widely perceived as complicated, speculative, or even unapproachable, into one which the user is more likely to understand as achievable and replicable. This is accomplished by demonstrating that, with the simple ingredients of time, investment, and commitment, actual long-term history demonstrates the simplicity, viability, and accessibility of investing and its benefits to anyone—regardless of volatile economic events, such as recessions, political changes, natural disasters, wars, etc.

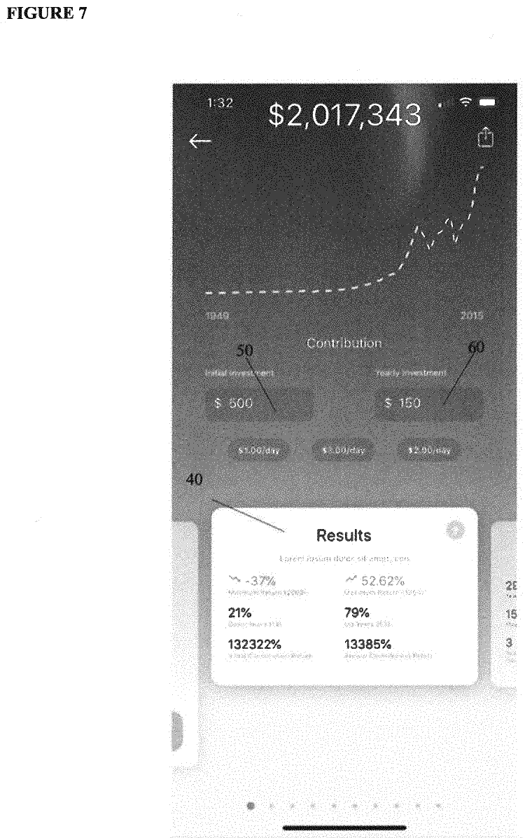

As shown in FIG. 7, in an exemplary embodiment of the investment learning system, the user inputs a starting investment amount, for instance, $500.00 in 1949 using a third input module 50 and commits $150.00 a year as a long term investment plan until a selected end date (i.e. 2015) using a fourth input module 60. This creates simulated financial results using a result module using a results algorithm based on historical data and events that occurred during the selected time period. In the shown embodiment, the selected inputs and simulated conditions produced a simulated financial result of $2,017,343 for the time period starting in 1949 and ending in 2015. The results module 40 will display simulated maximum and minimum yearly returns, simulated down years, simulated up years, simulated initial contribution return and a simulated annual contribution return through the general user interface. Minimum return and maximum return are calculated by using the range that the user selected. Each corresponding row in the database contains the return for the year. The minimum and maximum is calculated using the min by and max by methods to find the minimum and maximum values. Years down and years up involves selecting year rows with returns less than 0 and greater than 0 and then using the number of periods to generate a percentage (years down/total years OR years up/total years). Initial contribution and annual contribution return are calculated by iterating over each year and adding the value+value*annual return. For annual return, value would be increased by the annual contribution value+the previous summed value. Lastly, the mean annual rate of return is calculated by selecting all the annual returns for the periods selected and running this calculation: sum of annual returns/number of periods. Further, the investment learning system provides distinct dichotomy between up years and down years using graphics and colors in a dichromatic manner. This relationship serves to enhance efficacy of user education by adding an additional visual element, which assists in the goal of making complicated economic and financial concepts more relatable to the layperson. This relationship is intended to help individuals who might currently be intimated by investing/finance terms, gain the confidence to invest with understanding. The relationship is intended to be simple but effective in terms of user understanding. The benefit of giving individuals the confidence and know how to invest cannot however be understated. It is in fact a critical life skill in lieu of the referenced, quickly changing, and retirement demographics. This relationship further benefits the user by illustrating again, in yet another format, that volatility, in one form or another, is common in all periods, yet dispersion of long term historical investment trends is minimal and those trends are predominantly positive, evidencing the merits of a disciplined plan for long term investment.

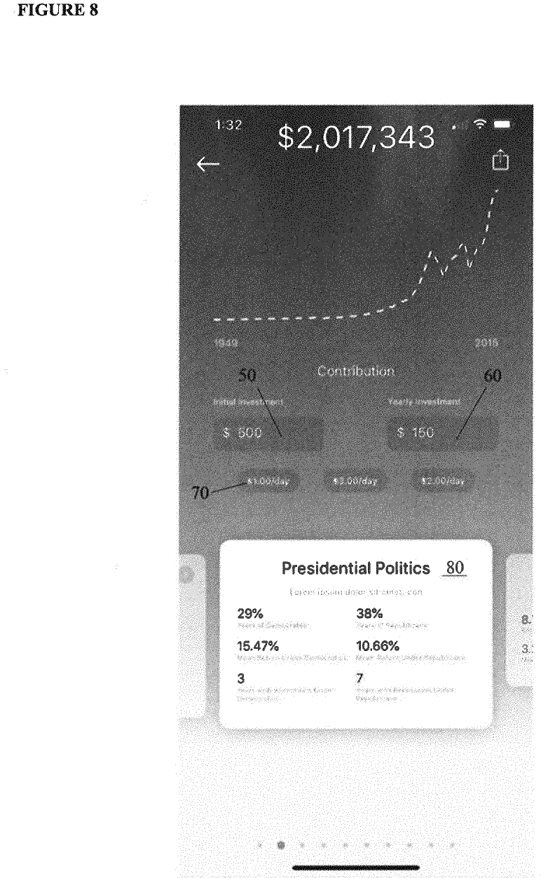

The user can change input of starting investment amount long term investment plan by manual input or by tapping on the pill shaped buttons in FIG. 8, using a quick input module 70. These buttons trigger an update of the “Yearly Investment” input and would equal Y*365=X. Y is the corresponding numeric value in the pill button. For example, pressing $1/day would trigger the input to equal $365 (1*365=365). That input is provided to the API and triggers a recalculation from the result module, simulating the maximum and minimum yearly returns, down years, up years, initial contribution return and annual contribution return through the general user interface.

As shown in FIG. 8, in an exemplary embodiment of the investment learning system provides political data using a political data module 80. This module pulls historical data concerning political leadership according to the simulated financial results through the results module and selected years through the first input module. For years of democrat and republican, it is a simple query and count in our database. Each period (year) has a column which designates which party was currently in the white house. Mean return for each party is calculated much like the mean return is calculated for the period in general except this filters out the opposing party. For example, mean return under democrats filters out the years which republicans were in the white house. For recessions under democrats and recessions under republicans, another simple query and count is used. Each period (year) has a column which designates if that year had a recession (two quarters of GDP decline). Again, the investment learning system illustrates comparative data using distinct dichotomy between political parties. This can be done graphically or using colors in a dichromatic manner. This relationship provides users with an understanding of social, economic, political, consumer related and other events that may impact, directly or indirectly stock market performance. This system further benefits the user by demonstrating the consistency of long-term investment trends, despite intra-period volatility triggered by said events.

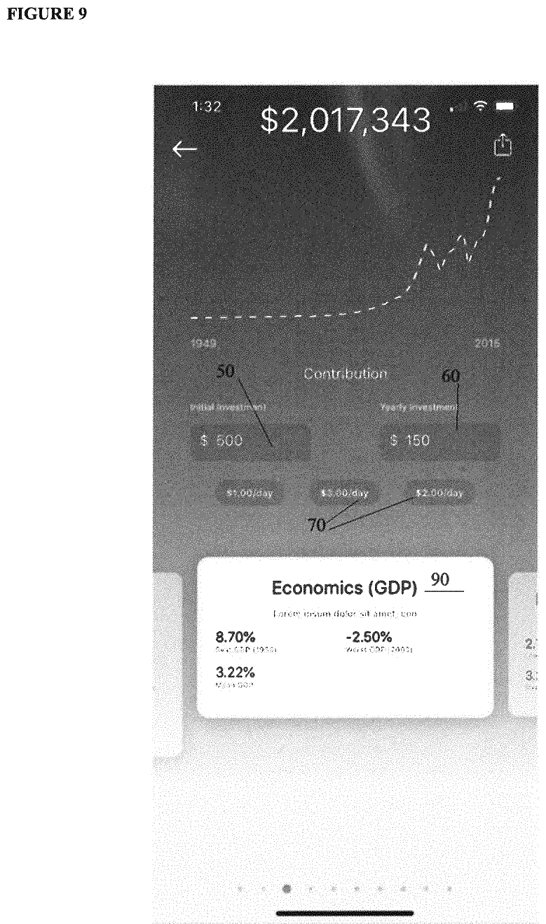

As shown in FIG. 9, in an exemplary embodiment of the investment learning system provides political data using an economics data module 90 that pulls historical data concerning employment, price-to-earnings ratio, and gross domestic product according to the simulated financial results through the results module 40 and selected years through first input module 20. Again, the investment learning system illustrates comparative data using distinct dichotomy between high and low years. For each item: unemployment, GDP, and P/E ratio, there are columns for the period which designate the unemployment rate, the GDP, and the P/E ratio for that year. To calculate the highest and lowest GDP, the module will find the max and min of the GDP columns based on the periods selected by the user. For the worst and best GDP, the simulation system does something similar, finding the min and max GDP. This is the same for lowest and highest P/E ratio. For years stocks were down and up 30%, a simple query and count was performed (find all periods where annual return was up 30% and down 30% and count). Much like the years with recessions in the political module, this counts all regardless of party. This can be done graphically or using colors in a dichromatic manner. This relationship provides users with an understanding of intra period volatility as well as events that trigger direct and indirect impact(s) on the stock market. In another embodiment, the economic data may provide comparative consumer data including, but not limited, tuition, median household price, and median mortgage payments. This is performed by an economic data module using an economic data algorithm to illustrate comparative economics in a distinct dichotomy between beginning and end years, the benefit of which is to demonstrate to the user that short-term volatility is ordinary and expected. The economy moves in cycles, with inflation, recession, stagnation, and so forth all being ordinary, short term fluctuations and even chaos being ordinary; yet, there is a reliable dichotomy of consistent and positive long-term trends for investment, particularly over full career cycles.

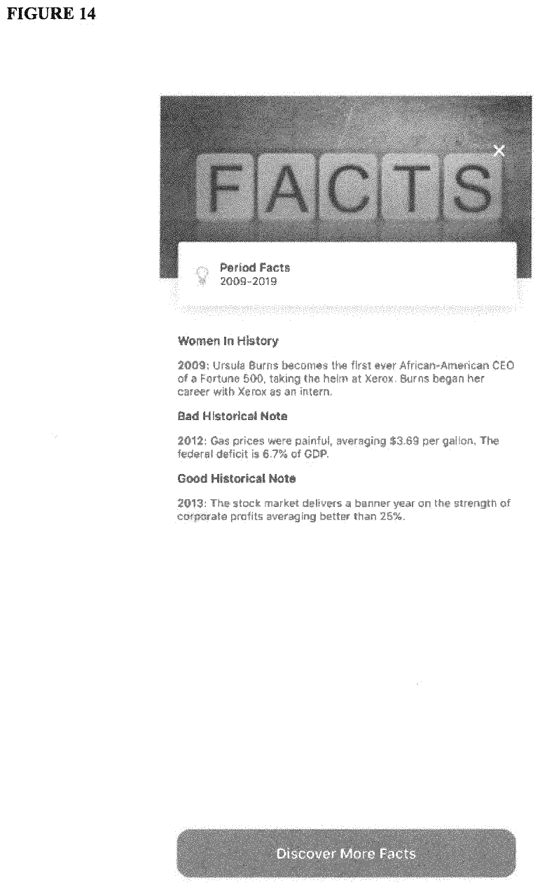

As shown in FIG. 14, the investment learn system provides interesting year based information surrounding the periods selected by the user. This facts module 100 pulls categorical data based on “Bad Historical Note,” “Good Historical Note,” “Innovation,” “Geopolitics,” “Random Note,” “Women in History,” “Natural Disaster,” “Transportation,” “Better Lucky Than Good,” etc. When “Discover More Facts” is tapped, new facts are generated.

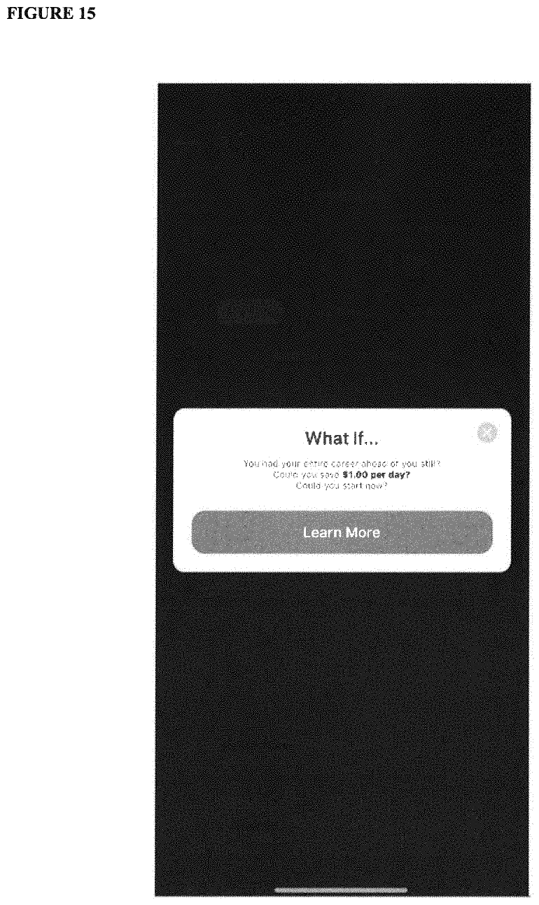

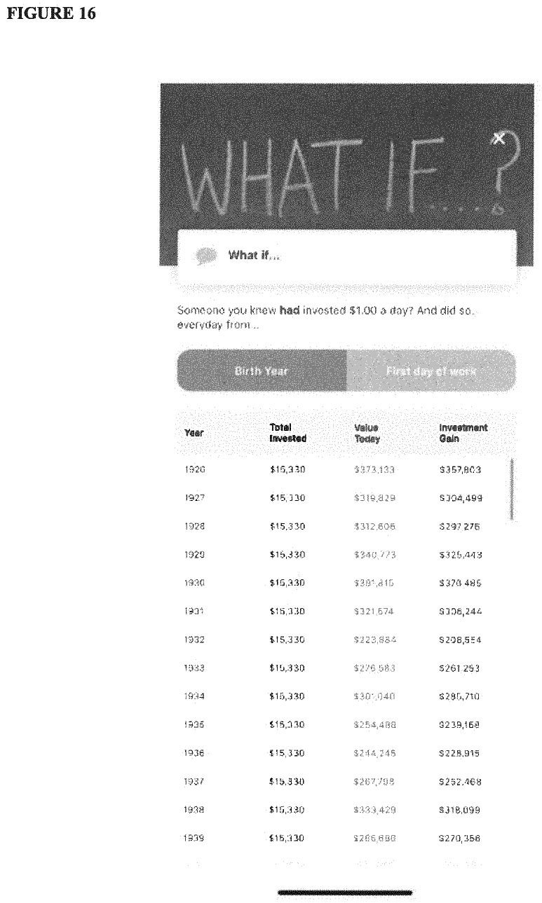

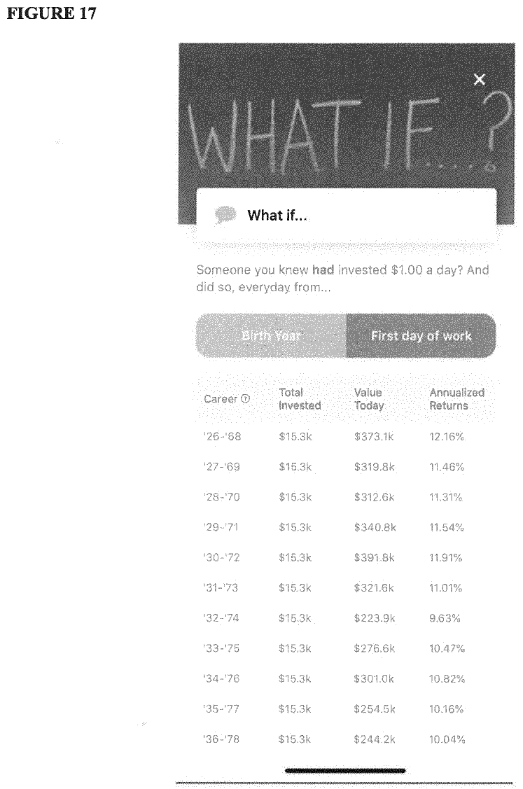

As is shown in FIGS. 15 and 16, the investment learning system provides a “what if” module 110 which displays the returns in two different scenarios: birth year till now and first day of work till retirement. For birth year (1929-2019), each year is passed through the same simulation system used in the main simulation system as if the birth year and 2019 is selected. Total investment is calculated from (2019−birth year)*365. Value today is the result of the main simulation system and investment gain is based on the result of the main simulation system—total investment. For the “First day of work” tab, a career is defined as 42 years. Total invested is calculated by this equation: 42*365. Value today is calculated with the main simulation system using the start and end date being the start and end year of the career. Annualized rate of return is calculated utilizing the money-weighted return methodology familiar to one practiced in the art. These annualized rate of return results are stored in a database, which are then accessible to the user via the software system. By tapping on the year range will trigger a popup (FIG. 17) which will display period facts pertaining to the year ranges tapped on.

In another exemplary embodiment of the invention, the investment learning system is targeted to provide a visual demonstration of long-term investing, even when faced with adverse short-term conditions by illustrating a distinct dichotomy between ups and down that occur frequently over the course of a long term investment term. Accordingly, investment learning system provides educational value to promote long term investment by lay investors, students and young professionals. Further, the investment learning system provides resource for educators and financial adviser to demonstrate the value of long term investment. It should be understood, that in carrying out the above algorithm, the investment learning system will then display an appropriate object, and animate or provide a graphic representation based on the simulated timeline, including simulated economic crisis. The displayed graphics may include one or more special features that are intended to stimulate investor interest in advancing towards a long term investment goal, and may include congratulatory or encouraging messaging. The graphic may be accompanied by a sound or audible commentary, such as may be provided by the software electing to play an audio file associated with the graphics displayed. For example, upon achieving milestone or rank, the investment learning system may play a celebratory fanfare, fireworks, or crowd applause to provide affirmation for the user's progress toward the milestone.

In another exemplary embodiment of the invention, the investment learning system is targeted to provide a visual demonstration of long-term investing, even when faced with adverse short-term conditions by illustrating a distinct dichotomy between ups and down that occur frequently over the course of a long term investment term. Accordingly, investment learning system provides educational value to promote long term investment by lay investors, students and young professionals. Further, the investment learning system provides resource for educators and financial adviser to demonstrate the value of long term investment.

It should be understood, that in carrying out the above algorithm, the investment learning system will then display an appropriate object, and animate or provide a graphic representation based on the simulated timeline, including simulated economic crisis. The displayed graphics may include one or more special features that are intended to stimulate investor interest in advancing towards a long term investment goal, and may include congratulatory or encouraging messaging. The graphic may be accompanied by a sound or audible commentary, such as may be provided by the software electing to play an audio file associated with the graphics displayed. For example, upon achieving milestone or rank, the investment learning system may play a celebratory fanfare, fireworks, or crowd applause to provide affirmation for the user's progress toward the milestone.

In the foregoing specification, the invention has been described with reference to specific embodiments thereof. It will be evident, however, that various modifications and changes may be made thereto without departing from the broader spirit and scope of the invention. For example, the reader is to understand that the specific ordering and combination of process actions described herein is merely illustrative, and the invention may appropriately be performed using different or additional process actions, or a different combination or ordering of process actions, including the ability for the user to personalize. Additionally and obviously, features may be added or subtracted as desired. Accordingly, the invention is not to be restricted except in light of the attached claims and their equivalents.

What is claimed is:

1. An investment learning system, comprising
a personal computer device having a single general user interface and a central processing unit; and
a performance management server connected to the personal computer device and having:
a non-transitory computer readable storage device having a database module for calculating and displaying simulated investment snapshot for a custom investment period utilizing historical data and user controlled inputs; and
a central processing unit connected to the personal computer device and the computer readable storage device, and running a plurality of core modules to map and link individual action items to calculate and generate integrated financial and managerial summaries, the plurality of core modules include:
a first input module to select a time period; and
a result module to generate simulated financial results based on historical events during that selected time period.

2. The investment learning system of claim 1, wherein the performance management server further includes a network router (for instance, a wireless router) and connected to a database server having the non-transitory computer readable storage device.

3. The investment learning system of claim 2, wherein the first input module is a time module that is activated by selecting a start date and an end date to reflect the select time period to simulated investment results based on historical events during that time period.

4. The investment learning system of claim 3, wherein the historical events include historical events that influenced on the United States or world economy by a defined percentage.

5. The investment learning system of claim 3, wherein a user selects historical events that are includes in the simulated investment results.

6. The investment learning system of claim 3, wherein the result module generates simulated trend and financial results for the selected time period based on a default initial investment and a default yearly investment.

7. The investment learning system of claim 6, wherein the plurality of core modules further includes a second input module whereby a user selects a custom initial investment to generate simulated trend and financial results for the selected time period.

8. The investment learning system of claim 7, wherein the plurality of core modules further includes a third input module whereby a user selects a custom yearly investment to generate simulated trend and financial results for the selected time period.

9. The investment learning system of claim 8, wherein the plurality of core modules limits the user from three inputs to generate simulated trend and financial results for the selected time period.

10. The investment learning system of claim 8, wherein the plurality of core modules further includes a political data module that pulls historical data concerning political leadership according to the simulated financial results through the results module and selected years through the first input module and provides a user with an understanding of social, economic, political, consumer related and other events that may impact, directly or indirectly financial results during the selected time period.

11. The investment learning system of claim 10, wherein the plurality of core modules further includes an economics data module that pulls historical data concerning employment, price-to-earnings ratio, or gross domestic product according to the simulated financial results through the results module and selected years through the first input module. Again, the

12. The investment learning system of claim 11, wherein the plurality of core modules further includes a “what if” module displaying returns by birth year till now and first day of work till retirement.

13. The investment learning system of claim 8, wherein the plurality of core modules provide a visual demonstration of long-term investing versus adverse short-term conditions by illustrating a distinct dichotomy between ups and down that occur frequently over the course of a long term investment term.

14. The investment learning system of claim 1, wherein the result module utilizes a results algorithm based on historical data and events that occurred during the selected time period.

15. The investment learning system of claim 14, wherein the results module will display simulated maximum and minimum yearly returns, simulated down years, simulated up years, simulated initial contribution return and a simulated annual contribution return through the general user interface.

16. The investment learning system of claim 15, wherein the investment learning system provides distinct dichotomy between up years and down years using graphics and colors in a dichromatic manner.
